(19) United States
(12) Patent Application Publication
(10) Pub. No.: US 2013/0085836 A1
(43) Pub. Date: Apr. 4, 2013

(54) METHOD FOR UNRESTRICTED COMMUNICATION BETWEEN USERS IN A SOCIAL MEDIUM OR NETWORK

(71) Applicant: PageBites, Inc., Palo Alto, CA (US)

(72) Inventors: Georges Harik, Palo Alto, CA (US); Ralph Harik, Palo Alto, CA (US); Nikola Borisov, Palo Alto, CA (US); Georgios Papoutsis, Menlo Park, CA (US)

(73) Assignee: PageBites, Inc., Palo Alto, CA (US)

(21) Appl. No.: 13/631,401

(22) Filed: Sep. 28, 2012

Related U.S. Application Data
(60) Provisional application No. 61/541,435, filed on Sep. 30, 2011.

(51) Int. Cl. G06Q 20/22; G06Q 30/02

(52) U.S. Cl. 705/14.39; 705/39

(57) ABSTRACT

A method allows participants of a social medium or network to unrestricted communication with each other (i.e., without first requiring a pre-established connection or relationship between the communicating participants), without an unacceptable risk of unwanted or unwelcomed communications. The method includes (a) allocating to each member an allocation of community currency units; (b) representing all members of the community in a graph in which each member is represented as a node and established relationships among the members are represented as edges; and (c) when a first member initiates an electronic communication with a second member, (i) evaluating a cost of the electronic communication by a measure that takes into consideration available paths in the graph that exist between the first member and the second member, (ii) modifying the cost of the electronic communication according to a set of pre-determined factors; (iii) deducting from the first member's allocation of community currency units the modified cost of the electronic communication; and (iv) effectuating the electronic communication.

### CROSS-REFERENCE TO RELATED APPLICATIONS

The present application relates to and claims priority of U.S. provisional patent application (“Provisional Application”), Ser. No. 61/541,435, entitled “Method for Unrestricted Communication between Users in a Social Medium or Network,” filed on Sep. 30, 2011. The Provisional Patent Application is hereby incorporated by reference in its entirety.

### BACKGROUND OF THE INVENTION

1. Field of the Invention

The present invention relates generally to social media or networks. In particular, the present invention relates to efficiently allowing communication between participants of social media.

2. Discussion of the Related Art

Communication among participants is an important use of a social medium. To avoid incidents of harassment or other unwelcomed communication, communication between any two participants in such a system typically cannot occur without a pre-established relationship or connection existing between them. For example, some systems require an established relationship between two members before either member can initiate communication with the other. In Facebook, for example, instant messaging is allowed between two users only if they have established themselves as “friends.” However, with respect to “messages” (a non-interruptive communication feature in Facebook that is separate from instant messaging), messages between members who are not “friends” are possible, but the system keeps track of instances of abuse and intervenes when required (e.g., taking away communication privileges).

### SUMMARY

According to one embodiment of the present invention, a method allows participants of a social medium or network to unrestricted communication with each other (i.e., without first requiring a pre-established connection or relationship between the communicating participants), without an unacceptable risk of unwanted or unwelcomed communications. The method includes (a) allocating to each member an allocation of community currency units; and (b) when a first member initiates an electronic communication with a second member, (i) evaluating a cost of the electronic communication by a measure that takes into consideration available paths in the graph that exist between the first member and the second member, (ii) modifying the cost of the electronic communication according to a set of pre-determined factors; (iii) deducting from the first member's allocation of community currency units the modified cost of the electronic communication; and (iv) effectuating the electronic communication. The participants may be represented in a graph in which each member is represented as a node and established relationships among the members are represented as edges;

According to one embodiment of the present invention, the cost of the electronic communication is assessed using a random walk graph model and wherein, the electronic communication varies according to the interruptive nature the electronic communication. Alternatively, the cost of the electronic communication varies according to the willingness of the second member in participating in the communication. The cost of the electronic communication may be determined by the recipient of the communication.

According to one embodiment of the present invention, each member is allocated a pre-determined number of community currency units, which are replenished at predetermined time points scheduled by the system. Each member may be rewarded with additional community currency units for sharing information with the system and with other members, and for interacting with other members. Alternatively, an unwelcome user may be penalized by having his or her community currency unit allocation reduced or eliminated. In a public on-line discussion, the cost of the electronic communication may vary according to whether or not the message is relevant to the subject of the discussion, or according to whether or not words generally considered offensive or impolite appear in the message.

The present invention is better understood upon consideration of the detailed description below.

### DETAILED DESCRIPTION OF THE PREFERRED EMBODIMENTS

According to one embodiment of the present invention, a system allows participants of a social medium or network to communicate with each other in an unrestricted manner (i.e., without first requiring a pre-established connection or relationship between the communicating participants), without an unacceptable risk of unwanted or unwelcomed communications. In this embodiment, the system keeps an account of unrestricted communication using a limited currency (“points”) that enables instant messaging, messaging, or other forms of information sharing among participants. In the following detailed description, the term “call” is understood to refer to a communication session using one or more of the covered communication modes (e.g., instant messaging, messaging, or other forms of information sharing among participants using electronic means, such as over a local or wide area computer network). Likewise, the initiator is referred to as the “caller” and the participant proposed to be contacted is referred to as the “callee.”

According to one embodiment of the present invention, a currency enables communication between participants who do not have a pre-established relationship, but the caller is required to expend his points. Prior to allowing the call, an accounting module deducts form the caller's account a required number of points. The number of points that a particular communication may cost depends on a number of factors including, for example, (a) the cost of reaching the callee (e.g., a “degree of separation”), (b) the interruptive nature of the method of communication or the method of communication itself (e.g., instant messaging, messaging or other forms of information sharing); (c) the willingness of the callee in participating in the communication (e.g., the callee is busy, available, bored, willing to meet new people); and (d) the time of day (e.g., night or day), or availability information from the participants' calendars. In one embodiment, the system allows the callee to determine the number of points at the time of communication. Alternatively, the caller and the callee may jointly determine the cost of the communication in points. Other factors may include, for example, whether the participants are working for the same company, attended the same college, or replied to the initiator using the same communication method in recent past (e.g., the last day or a pre-determined number of days).

The cost determination need not be statically determined from time to time, at predetermined time intervals, but may be determined at the time of the intended communication. For example, dynamic factors that may be considered include (a) the number of calls initiated by a caller over a predetermined time period (e.g., 3 hours); (b) the number of calls initiated by a caller that are refused or ignored over a predetermined time period; (c) the number of the calls received by a callee over a predetermined time period. For example, the cost of communication charged to a caller who has recently been repeatedly refused or ignored may be increased. The cost of communication with a callee is successively increased for a caller whose last contact or contacts with the callee are ignored or refused. Generally, the cost of communication reflects, in a sense, a value judgment on a call's degree of imposition on the specific callee by the specific caller. Thus, generally, the cost of communication may be assessed according to a measure of desirability of the caller relative to the callee. Likewise, the cost of communication may also be greater for highly sought after callee.

In one system, a server in the social medium or network authorizes each call between parties who do not have a pre-established relationship between them. The call does not proceed unless the caller's account has the requisite number of points for the intended call. In one embodiment, each user of the social medium or network is allocated a pre-determined number of points daily, or more frequently, as appropriate. A point allocation event for any user may be scheduled by the system at any time, if preferred. To encourage a user to share information with the system and with other participants, a user's regularly allocated points may be increased for providing a more complete profile (e.g., age, interests, gender, educational background, and willingness to accept contact requests from unrelated participants). To encourage participation, a participant may be rewarded with additional points based on interactions with other participants.

Alternatively or additionally, a user may acquire points from the service provider by, for example, an exchange of items of value (e.g., payment by an online payment service or a credit card). In some instances, if the system is found to be abused, points allocated to the abusive user may be reduced or eliminated. The penalty may be reduced over a period of time, for example (e.g., the reduced daily allocation is incrementally restored over a period of a month). In one embodiment, none of the points deducted from the initiator's account for calls initiated is credited to the callee. In other systems, however, it is possible that some or all of the points deducted from the initiator are credited to the callee. In some instances, additional points may be charged the initiator for the amount of communication (e.g., duration of the call, number or frequency of messages sent). Using such a currency-enabled system reduces the possibility of an unwanted or unwelcomed call to a member of the social medium or network by another member using the covered communication modes, without prohibiting uninvited contacts between the members.

In one embodiment, the connections between participants are represented by a graph, in which the participants are each being represented by a node and direct pre-established relationships between participants are each being represented by an edge. Using such a model, the cost of a communication between two participants may be assigned based on a measure of “connectedness” between the two nodes representing the participants. For example, each edge may be assigned a “distance” value and the cost of communication may relate to a measure taking into consideration the distances in all the paths between two nodes (e.g., an average of the weighted path lengths). The distances may be weighted, for example, by the various factors discussed above that affect the cost of communication. Thus, two participants who are not directly connected to each other may nonetheless communicate at low cost if there are many low-cost paths that indirectly connect them. (Such a measure may be an indication of a likelihood that the two participants may know or know of each other). The cost of reaching any participant from a given participant may be evaluated dynamically, for example, using a random walk over such a graph (i.e., a Markov chain model) to provide a measure of the reachability between nodes. The Markov chain can also be run until its stationary distribution is discovered, which would assign a constant reachability factor for any user regardless of the starting point.

In one embodiment, when the communication among participants is in the form of a public on-line discussion. The cost of posting a message in the discussion may be assessed according to whether or not the message is relevant to the subject of the discussion and whether or not certain words generally considered offensive or impolite appear in the message. Such assessment may be made, for example, based on existence of key words and their respective frequencies of use in the rest of the discussions. In one embodiment, the cost of posting a message may be assessed according to the identities of the participants who have already posted and the relationships (if any) between the new poster and each of the existing participants.

A random walk model may also be used to determine the point allocation appropriate for a given participant based on the interactions between the participants and other participants. The Markov chain may be modified to eliminate absorbing states (every state has a non-zero probability to transition to another state). The random walk over the graph results in a stationary probability distribution (the “limiting distribution”) on the nodes. The limiting distribution provides a probability on each node (representative of the probability that the user communicates with another) which can be mapped to a point allocation. The exact function based on the stationary probability is not important; the function needs only be monotonically increasing with the stationary probability. The following functions are examples that may be used for point allocation, where x represents the stationary probability resulting from the random walk over the graph:

f(x)=x

f(x)=x²

f(x)=if(x<0.5)then 1 else 2

In one system, points that are used between users are not refundable by a callee to the caller. Such a policy protects a callee from being pressured or harassed by the caller to refund the points. As a result, a system can be created that allows many users to feel comfortable making themselves available to communicating with almost all other users in the social medium or network, albeit for a price.

The above detailed description is provided to illustrate specific embodiments of the present invention and is not intended to be limiting. Numerous modifications and variations with in the scope of the present invention are possible. The present invention is set forth in the accompanying claims.

We claim:

1. A method for facilitating electronic communication between any two or more members of a community without requiring an established relationship between the two members, comprising:
allocating to each member an allocation of community currency units;
determining dynamically a cost of an electronic communication, expressed in community currency units between a calling member and one or more called members based on information at the time of electronic communication regarding the calling member, the called members and the electronic communication;
deducting from the calling member's allocation of community currency units the cost of the electronic communication; and
effectuating the electronic communication.

2. The method of claim 1 where the community is represented in a graph in which each member is represented as a node and established relationships among the members are represented as edges.

3. The method of claim 2, wherein the allocation of communication is based at least in part on a random walk over the graph.

4. The method of claim 2, wherein the cost of the electronic communication is based at least in part on a random walk over the graph.

5. The method of claim 1, wherein the cost of the electronic communication varies according to the interruptive nature the electronic communication.

6. The method of claim 1, wherein the cost of the electronic communication varies according to the willingness of each called member in participating in the communication.

7. The method of claim 1, wherein each called member determines a portion in the cost of the electronic communication.

8. The method of claim 1, wherein the calling member and the called members jointly determine the cost of the communication.

9. The method of claim 1, wherein each member is allocated a pre-determined number of community currency units.

10. The method of claim 1, wherein each member may be scheduled by the system to replenish the community currency units.

11. The method of claim 1, wherein each member is rewarded by an increase in the allocation of community currency units for sharing information with the system and with other members.

12. The method of claim 1, each member may be rewarded with additional community currency units based on interactions with other members.

13. The method of claim 1, wherein the cost of electronic communication varies with a measure that assesses each participant's desirability.

14. The method of claim 1, wherein the community currency units allocated to an unwelcome user may be reduced or eliminated.

15. The method of claim 1, wherein the electronic communication comprises an on-line discussion, and wherein the cost of the electronic communication varies according to whether or not the message is relevant to the subject of the discussion.

16. The method of claim 1, wherein the cost of the electronic communication varies according to whether or not words that are considered offensive or impolite appear in the message.

17. The method of claim 1, wherein the electronic communication comprises an on-line discussion, and wherein the cost of the electronic communication varies according to the identities of participants already in the discussion and the relationships among the participants and the caller represented in the graph.
